(19) United States
(12) Patent Application Publication
(10) Pub. No.: US 2007/0226380 A1
(43) Pub. Date: Sep. 27, 2007

(54) Unit detection apparatus, unit detection method and unit detection program

(75) Inventor: Yoshiki Akiyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/447,922

(22) Filed: Jun. 7, 2006

(30) Foreign Application Priority Data
Mar. 10, 2006 (JP) 2006-065455

(51) Int. Cl. G06F 3/00

(52) U.S. Cl. 710/15

(57) ABSTRACT

The present invention provides a unit detection apparatus which can be easily miniaturized and simplified, and can prevent occurrence of operation mistake etc. by automatically detecting units without human works of a worker, and do not bring about a secondary failure. The unit detection apparatus, includes unit information detection sections that are arranged in adapters to which the respective units are attached and detect unit information related to the units, command transfer sections that are arranged respectively in the adapters and add the unit information detected by the unit information detection sections to received commands based on the commands, and transfer the commands, and a unit information acquisition section that receives the commands which are transferred from the command transfer sections of all the adapters, and acquires the unit information which is related to all the units and added to the commands.

### BACKGROUND OF THE INVENTION

1. Field of the Invention

The present invention relates to a unit detection apparatus, a unit detection method, and a unit detection program which automatically detect units of a tape library, etc.

2. Description of the Related Art

For example, in a tape library apparatus as an example of a unit detection apparatus, since a robot control section sets a medium to drive units, a main control section that gives a designation to the robot control section has to detect the drive units.

In case of a conventional small-sized library apparatus, since several drive units are required to be detected, the main control section and the drive units are directly connected using a one-on-one cable.

On the other hand, in case of a conventional large-sized library apparatus, a physical switch is attached to drive units, and the main control section and the respective drive units are connected using a cable, and the main control section recognizes the physical position of individual drive unit which is set by the physical switch.

FIG. 5 shows a block diagram of one example of a conventional large-sized tape library apparatus. A main control section 13 gives a designation from a host 14 to a robot control section 15 through a robot control path 18. A plurality of drive units 20A to 20N are connected to the host 14 through other lines 19, and the drive units 20A to 20N are set to adapters 10A to 10N (drive unit reception circuits) respectively.

The drive units 20A to 20N and the main control section 13 are connected using a cable 16 one after another, and the setting status of address switches 17 arranged on the adapters 10A to 10N of the drive units 20A to 20N is detected through the cable 16. As a related technique, there is known a Patent Document 1 (Jpn. Pat. Appln. Laid-Open Publication No. 10-177754).

However, in above described small-sized library apparatus, since the main control section and reception circuits of the respective drive units are connected using a one-on-one cable, the cable routing is required for mounting the drive units, which raises a problem that the entire tape library apparatus cannot be miniaturized.

On the other hand, in the large-sized library apparatus, since the physical position of individual drive unit is recognized by setting a physical switch being an address switch, there may be raised an error in detecting the drive units due to a setting operation mistake of the physical switch. In case of exchanging a drive unit for maintenance exchange under the active state, there is raised a problem that a secondary failure may be induced.

Furthermore, in case of the large-sized library apparatus, it is necessary that a physical switch be attached to a position where a maintenance staff can operate the physical switch, which raises a problem that the cable routing inside the apparatus comes to be complicated.

### SUMMARY OF THE INVENTION

It is therefore an object of the present invention to overcome the above-mentioned drawbacks by providing a unit detection apparatus, a unit detection method, and a unit detection program which can be easily miniaturized and simplified, and can prevent occurrence of operation mistake etc. by automatically detecting units without human works of a worker, and do not bring about a secondary failure.

According to the present invention, there is provided a unit detection apparatus that detects a plurality of units, including: unit information detection sections that are arranged in adapters to which the respective units are attached and detect unit information related to the units; command transfer sections that are respectively arranged in the adapters and add the unit information detected by the unit information detection sections to received commands based on the commands, and transfer the commands; and a unit information acquisition section that receives the commands which are transferred from the command transfer sections of all the adapters, and acquires the unit information which is related to all the units and added to the commands.

Furthermore, according to the unit detection apparatus, the unit information detection sections detect connection/connectionless information between the units and the adapters.

According to the present invention, there is also provided a unit detection method that detects a plurality of units, including; a unit information collection step that sequentially transfers predetermined commands among a plurality of adapters to which the respective plural units are attached, and, in the respective adapters, adds unit information which is related to the respective units and detected by the respective adapters to the predetermined commands; and a unit information acquisition step that receives the predetermined commands which are transferred among all the adapters in the unit information collection step, and acquires the unit information related to the plural units.

According to the present invention, there is also provided a unit detection program that is to be executed by a control circuit at adapters to which a plurality of units are attached so as to detect the respective units, the program making the control circuit execute the steps including; a reception judgment step that judges whether or not a signal is received; a command judgment step that, in case it is determined in the reception judgment step that a signal is received, judges whether or not a predetermined command is received; and a transfer step that, in case it is determined in the command judgment step that the predetermined command is received, acquires information related to the units, and adds thus acquired unit information to the predetermined command to transfer the command, while, in case it is determined that the predetermined command is not received, directly transfers a received signal.

As described above, according to the present invention, it becomes possible to provide a unit detection apparatus, a unit detection method, and a unit detection program which can be easily miniaturized and simplified, and can prevent occurrence of operation mistake etc. by automatically detecting units without human works of a worker, and do not bring about a secondary failure.

### BRIEF DESCRIPTION OF THE DRAWINGS

FIG. 1 shows a block diagram of the periphery of drive units of a tape library apparatus according to an embodiment of the present invention;

FIG. 2 is a block diagram showing the configuration of each adapter;

FIG. 3 shows a sequence chart indicative of the performance in the embodiment of the present invention;

FIG. 4 shows a flowchart indicative of the processing of each adapter; and

FIG. 5 shows a block diagram of a conventional tape library apparatus.

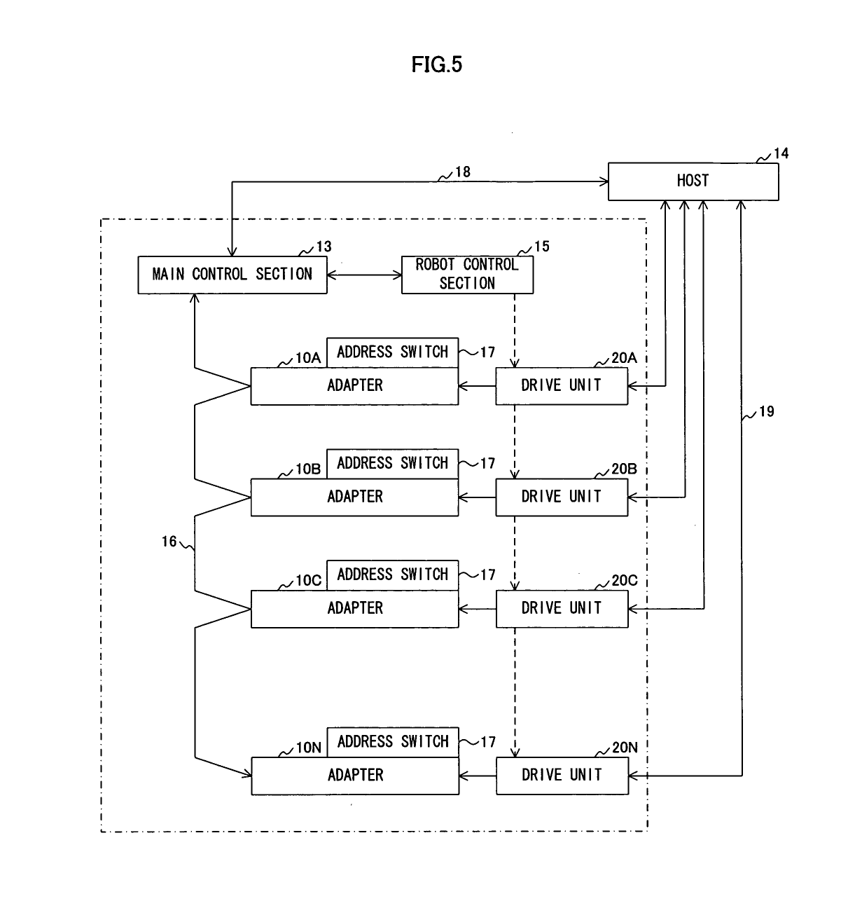

### DETAILED DESCRIPTION OF THE PREFERRED EMBODIMENTS

The embodiments of the present invention will further be described below with reference to the accompanying drawings.

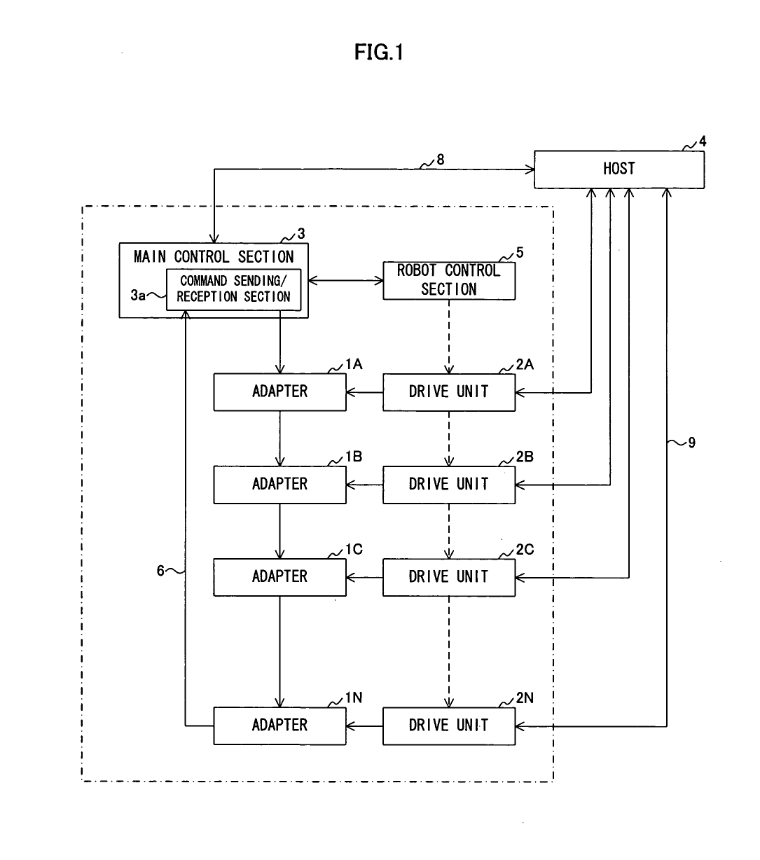

FIG. 1 shows a block diagram of the periphery of drive units of a tape library apparatus according to an embodiment of the present invention. In the configuration shown in FIG. 1, the tape library apparatus includes a plurality of drive units 2A to 2N, adapters (drive unit reception circuits) 1A to 1 N of the respective drive units 2A to 2N, a robot control section 5 of a robot, not shown, which sets a medium being a tape to the respective drive units 2A to 2N, a host 4 that sends/receives data to/from the respective drive units 2A to 2N through a data pass 9, and a main control section 3 that receives a designation related to a performance designation of the robot control section 5 from the host 4 through a robot control path 8, receives unit connection information related to the connection/connectionless of the drive units 2A to 2N and unit status information related to the status of the drive units 2A to 2N from the respective adapters 1A to 1N through a serial communication path 6, and issues a performance designation to the robot control section 5 based on those signals.

The unit information related to the connection/connectionless and the status of the drive units 2A to 2N is obtained by the main control section 3 so as to perform data communication with the drive units 2A to 2N after the host 4 determines addresses for the drive units 2A to 2N.

The main control section 3 has a command sending/reception section 3a that sends a termination code as a predetermined command of the present invention to the first adapter 1A, and makes the respective adapters sequentially transfer the command up to the last adapter 1N, and then receives the command from the last adapter 1N.

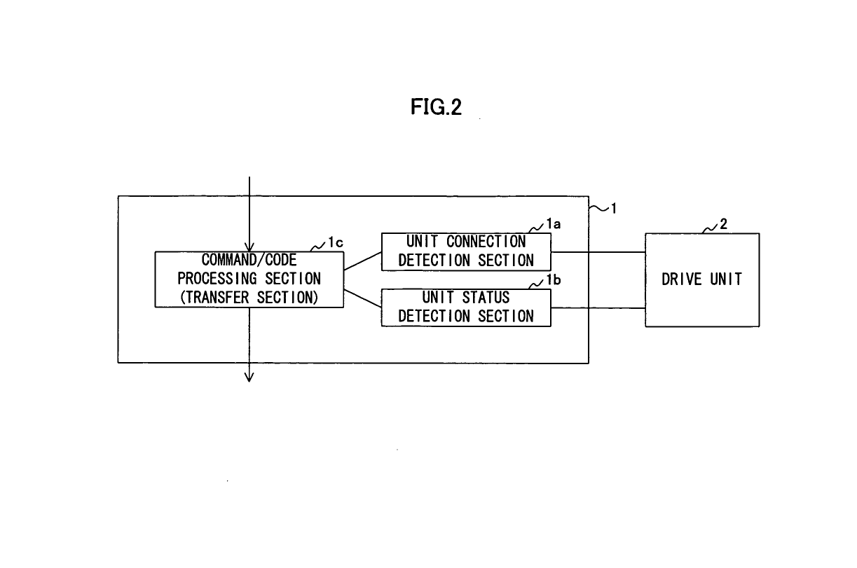

FIG. 2 shows a block diagram of the configuration of the respective adapters 1A to 1N. Each of the adapters 1A to 1N includes a unit connection detection section 1a that detects whether or not each of the drive units 2A to 2N is connected and outputs unit connection information, a unit status detection section 1b that outputs unit status information related to the status (power on/off, normal/abnormal, etc.) of each of the drive units 2A to 2N, and a command/code processing section 1c that adds information from these detection sections 1a, 1b to a command and sequentially transfers the command based on the termination code, to be described later, sent from the main control section 3. The command/code processing section 1c configures a command transfer section of the present invention.

Next, the performance in the embodiment, or the communication performance between the main control section 3 and the adapters 1A to 1N will be explained. In the present embodiment, the serial communication is employed, in which a communication signal is sent from the main control section 3 and sequentially transferred among the plural adapters 1A to 1N.

The main control section 3 sends a serial communication signal to the first adapter 1A, and the first adapter 1A makes its unit connection detection section 1a detect the connection/connectionless of the drive unit 2A, while makes its unit status detection section 1b detect the status of the drive unit 2A, and adds information related to the connection/connectionless and the status of the drive unit 2A to serial communication data to send the serial communication data to the second adapter 1B.

Similarly, the second adapter 1B makes its unit connection detection section la detect the connection/connectionless of the drive unit 2B, while makes its unit status detection section 1b detect the status of the drive unit 2B, and adds information related to the connection/connectionless and the status of the drive unit 2B to serial communication data to send the serial communication data to the third adapter 1C.

In above-described performance, based on the unit connection information sent from the unit connection detection section 1a, in case the drive unit is not connected, the command/code processing section 1c adds information that the drive unit is not connected as well as information of the order of the adapter to data (termination code) of serial communication from the previous stage.

On the other hand, in case the drive unit is connected, the command/code processing section 1c adds information that the drive unit is connected as well as information of the order of the adapter to data (termination code) of serial communication from the previous stage, and sends the data to the adapter of the subsequent stage.

Furthermore, concurrently, based on the unit status information sent from the unit status detection section 1b, the command/code processing section 1c adds information related to the status (power on/off, normal/abnormal, etc.) of the drive unit together with above-described additional information. The command/code processing section 1c configures a command transfer section of the present invention, and above-described successive steps configure unit information collection steps.

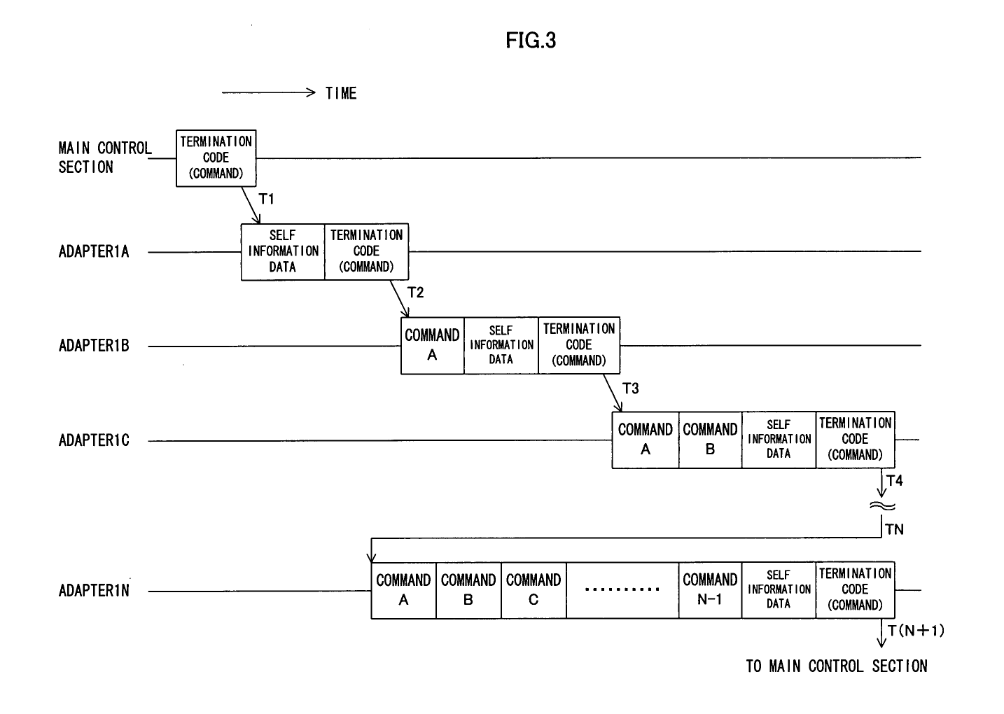

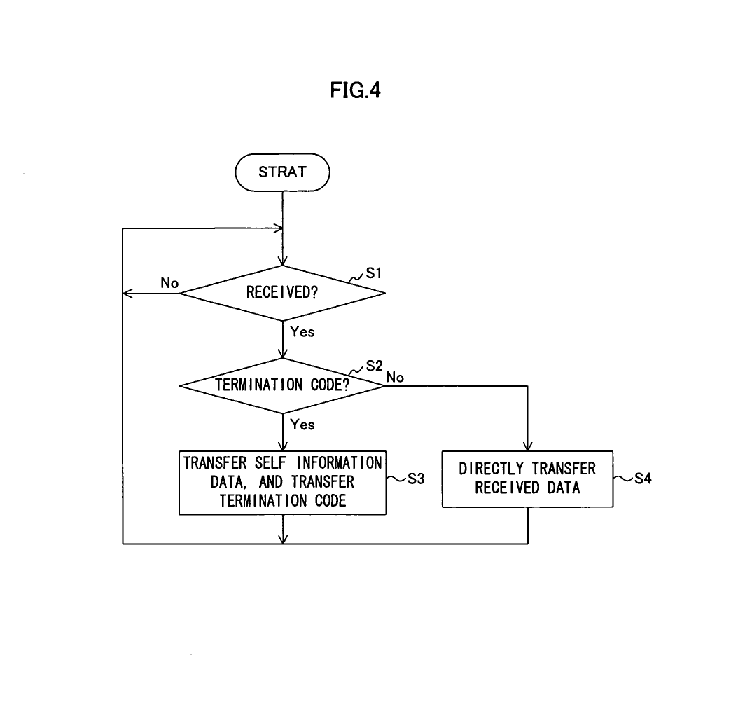

FIG. 3 shows a sequence chart indicative of above-described performance, while FIG. 4 shows a flowchart indicative of the processing (unit information collection steps) of the respective adapters in above-described performance.

The command sending/reception section 3a of the main control section 3 sends the termination code to the first adapter 1A (T1). When receiving the termination code (Step S1, Yes), the first adapter 1A recognizes that the adapter is the first adapter due to the reception of the command (termination code) (Step S2, Yes), and detects the information related to the connection/connectionless and additional information of its drive unit 2A, and sends a command A and command (termination code) to the adapter 1B of the subsequent stage (T2) (Step S3).

On reception from the first adapter 1A (Step S1, Yes), the second adapter 1B receives the command A to analyze the command A, and finds out that the first information is added thereto. In this case, not being the termination code (Step S2, No), the second adapter 1B directly sends the command A to the adapter of the subsequent stage (Step S4).

Next, on reception (Step S1, Yes), the second adapter 1B recognizes that the adapter is the second adapter due to the received command (termination code) (Step S2, Yes), and detects the information related to the connection/connectionless and additional information of its drive unit 2B, and sends a command B and command (termination code) after above-described command A to the adapter 1C of the subsequent stage (T3) (Step S3).

Afterward, similarly, the third adapter 1C receives the command A and command B to analyze the command A and command B, recognizes that the adapter is the third adapter after receiving the termination code, detects the information related to the connection/connectionless and additional information of its drive unit 2C, and sends commands to the adapter of the subsequent stage (T4).

A signal sent from the adapter IN of the last stage is returned by a connector section to the subsequent stage to be returned to the command sending/reception section 3a of the main control section 3 (unit information acquisition step) (T(N+1)).

The command sending/reception section 3a of the main control section 3 receives the command A, command B, command N, and command (termination code) from the adapters 1A to 1N, and can recognize the status of all the drive units 2A to 2N. Configuring above-described adapters, it becomes possible to automatically set and recognize physical positions of drive units to be expanded without manual operations.

In above-described embodiment of the present invention, it becomes possible to make a control circuit execute a unit detection method by storing the steps in the flowchart shown in FIG. 4 as a unit detection program in a computer-readable recording medium. In the present invention, the computer-readable recording medium may be a portable recording medium such as a CD-ROM, flexible disk, DVD disk, magnet-optical disk, IC card, or a database storing computer programs, or other computers and their databases, or a transmission medium on a line.

What is claimed is:

1. A unit detection apparatus that detects a plurality of units, comprising:
unit information detection sections that are arranged in adapters to which the respective units are attached and detect unit information related to the units;
command transfer sections that are arranged respectively in the adapters and add the unit information detected by the unit information detection sections to received commands based on the commands, and transfer the commands; and
a unit information acquisition section that receives the commands which are transferred from the command transfer sections of all the adapters, and acquires the unit information which is related to all the units and added to the commands.

2. The unit detection apparatus according to claim 1, wherein
the unit information detection sections detect connection/connectionless information between the units and the adapters.

3. The unit detection apparatus according to claim 1, wherein
the unit information detection sections detect status information of the units.

4. The unit detection apparatus according to claim 1, wherein
the units are drive units of a tape library apparatus, and
the unit information acquisition section makes a main control section, which gives a designation to a robot control section that delivers a tape to the drive units, acquire the unit information.

5. A unit detection method that detects a plurality of units, comprising:
a unit information collection step that sequentially transfers predetermined commands among a plurality of adapters to which the respective plural units are attached, and, in the respective adapters, adds unit information which is related to the respective units and detected by the respective adapters to the predetermined commands; and
a unit information acquisition step that receives the predetermined commands which are transferred among all the adapters in the unit information collection step, and acquires the unit information related to the plural units.

6. The unit detection method according to claim 5, wherein
the unit information includes connection/connectionless information between the units and the adapters.

7. The unit detection method according to claim 5, wherein
the unit information includes status information of the units.

8. The unit detection method according to claim 5, wherein
the units are drive units of a tape library apparatus, and
the unit information acquisition step makes a main control section, which gives a designation to a robot control section that delivers a tape to the drive units, acquire the unit information.

9. A unit detection program that is to be executed by a control circuit at adapters to which a plurality of units are attached so as to detect the respective units, the program making the control circuit execute the steps comprising:
a reception judgment step that judges whether or not a signal is received;
a command judgment step that, in case it is determined in the reception judgment step that a signal is received, judges whether or not a predetermined command is received; and
a transfer step that, in case it is determined in the command judgment step that the predetermined command is received, acquires information related to the units, and adds thus taken in unit information to the predetermined command to transfer the command, while, in case it is determined that the predetermined command is not received, directly transfers a received signal.

10. The unit detection program according to claim 9, wherein
the transfer step transfers connection/connectionless information between the units and the adapters as information related to the units.

11. The unit detection program according to claim 9, wherein
the transfer step transfers status information of the units as information related to the units.

12. The unit detection program according to claim 9, wherein
the units are drive units of a tape library apparatus, and the adapters are reception circuits of the drive units.
